(19) United States
(12) Patent Application Publication
(10) Pub. No.: US 2025/0392799 A1
(43) Pub. Date: Dec. 25, 2025

(54) PERSONALIZED SUMMARY VIDEO SYSTEM AND METHOD

(71) Applicant: NBCUniversal Media, LLC, New York, NY (US)

(72) Inventors: David McLary, New York, NY (US); Joanna Wraszczyk, New York, NY (US); John Jelley, New York, NY (US); Ilmir Moussikaev, New York, NY (US)

(21) Appl. No.: 19/246,391

(22) Filed: Jun. 23, 2025

Related U.S. Application Data
(60) Provisional application No. 63/663,612, filed on Jun. 24, 2024.

(51) Int. Cl. H04N 21/8549; G06F 3/0482

(52) U.S. Cl. CPC H04N 21/8549; G06F 3/0482

(57) ABSTRACT

A computer-implemented includes determining, via processing circuitry, user preference data relating to a user and a television or streaming event. The computer-implemented method also includes determining, via the processing circuitry and based on the user preference data, a sub-set of media samples from a plurality of media samples stored in a database system and corresponding to the television or streaming event. The computer-implemented method also includes determining, via the processing circuitry, personal data indicative of the user. The computer-implemented method also includes generating, via the processing circuitry, based on generative Artificial Intelligence (GenAI) techniques, and based on the personal data, a summary video voiceover. The computer-implemented method also includes generating, via the processing circuitry, a summary video of the television or streaming event, the summary video comprising the sub-set of media samples and the summary video voiceover.

### CROSS-REFERENCE TO RELATED APPLICATIONS

This application claims priority to and the benefit of U.S. Provisional Application No. 63/663,612, entitled “PERSONALIZED SUMMARY VIDEO SYSTEM AND METHOD,” filed Jun. 24, 2024, which is incorporated by reference herein in its entirety for all purposes.

### BACKGROUND

The present disclosure relates generally to generating personalized summary video. More specifically, the present disclosure relates to Artificial Intelligence (AI) techniques employed to generate a personalized summary video (e.g., continuous video, video presented in the form of a playlist with discrete segments, etc.), such as a daily personalized summary video relating to one or more sporting events, with respect to user preferences and/or other user personal data.

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Certain affairs or events, such as televised or streamed multi-sport, multi-day, multi-episode, and/or multi-season affairs or events (e.g., the Olympics, the Commonwealth games, the Pan American Games, the Asian Games, the Mediterranean Games, reality television (TV) programs, such as a reality TV season or series, music festivals, primary or general elections and corresponding coverage, seasons of sports leagues such as the National Basketball Association (NBA), the Premier League, the National Football League (NFL), Major League Baseball (MLB), and others, a sitcom season and/or series, a movie series, etc.), have a wealth of media (e.g., digital media, including video highlights, expert commentary, etc.) available to observers of the affair or event. In traditional configurations, observers may select individual media samples, including highlights and other coverage, of various aspects of the affair or event that are of interest to the observers. For example, an observer of the Olympics may select, from a plethora of media samples, a highlight package corresponding to a sport that the observer finds interesting. Due to the vast number of media samples available for observation, the process of selecting particular media samples that are of interest to the observer, and loading them onto a device of the observer, can be cumbersome, time consuming, and/or inefficient. Further, a traditional application employing the above-described features is impersonal, which may lead to relatively low viewership and/or relatively low returning customers. For these and other reasons, it is now recognized that improved systems and methods are desired.

### BRIEF DESCRIPTION

Certain examples commensurate in scope with the originally claimed subject matter are summarized below. These examples are not intended to limit the scope of the claimed subject matter, but rather these examples are intended only to provide a brief summary of possible forms of the subject matter. Indeed, the subject matter may encompass a variety of forms that may be similar to or different from the examples set forth below.

In an example, a computer-implemented method includes determining, via processing circuitry, user preference data relating to a user and a television or streaming event. The computer-implemented method also includes determining, via the processing circuitry and based on the user preference data, a sub-set of media samples from a plurality of media samples stored in a database system and corresponding to the television or streaming event. The computer-implemented method also includes determining, via the processing circuitry, personal data indicative of the user. The computer-implemented method also includes generating, via the processing circuitry, based on generative Artificial Intelligence (GenAI) techniques, and based on the personal data, a summary video voiceover. The computer-implemented method also includes generating, via the processing circuitry, a summary video of the television or streaming event, the summary video comprising the sub-set of media samples and the summary video voiceover.

In another example, one or more tangible, non-transitory, computer-readable media includes instructions stored thereon that, when executed by processing circuitry, are configured to cause the processing circuitry to perform various functions. The functions include determining user preference data relating to a user and a television or streaming event, and determining, based on the user preference data, a sub-set of media samples from a plurality of media samples stored in a database system and corresponding to the television or streaming event. The functions also include determining personal data indicative of the user, and generating, based on generative Artificial Intelligence (GenAI) techniques and based on the personal data, a summary video voiceover. The functions also include generating a summary video of the television or streaming event, the summary video comprising the sub-set of media samples and the summary video voiceover.

In another example, a system includes a database system storing a plurality of media samples relating to a television or streaming event. The system also includes processing circuitry configured to determine user preference data relating to a user and the television or streaming event, and to determine, based on the user preference data, a sub-set of media samples from the plurality of media samples stored. The processing circuitry is also configured to determine personal data indicative of the user, and to generate, based on generative Artificial Intelligence (GenAI) techniques and based on the personal data, a summary video voiceover. The processing circuitry is also configured to generate a summary video of the television or streaming event, the summary video comprising the sub-set of media samples and the summary video voiceover.

### DRAWINGS

These and other features, aspects, and advantages of the present disclosure will become better understood when the following detailed description is read with reference to the accompanying drawings in which like characters represent like parts throughout the drawings, wherein:

FIG. 1 is a schematic illustration of a system configured to generate personalized summary videos of an event, such as daily personalized summary videos of a television or streaming event (e.g., a multi-sport event), using Artificial Intelligence (AI) techniques, in accordance with examples of the present disclosure;

FIG. 2 is a process flow diagram illustrating a workflow implemented by the system of FIG. 1 to generate personalized summary videos of an event, such as daily personalized summary videos of a television or streaming event (e.g., a multi-sport event), using Artificial Intelligence (AI) techniques, in accordance with examples of the present disclosure;

FIG. 3 is a process flow diagram illustrating various logic (e.g., hardware and/or software) employed in certain steps of the workflow of FIG. 2 for generating personalized summary videos of an event, such as daily personalized summary videos of a television or streaming event (e.g., a multi-sport event), using Artificial Intelligence (AI) techniques, in accordance with examples of the present disclosure;

FIG. 4 is a schematic illustration of a playlist structure corresponding to a daily personalized playlist including personalized summary video clips and deliverable to an end user, in accordance with examples of the present disclosure; and

FIG. 5 is a process flow diagram illustrating a method of generating personalized summary videos of an event, such as daily personalized summary videos of a television or streaming event (e.g., a multi-sport event), using Artificial Intelligence (AI) techniques, in accordance with examples of the present disclosure.

### DETAILED DESCRIPTION

One or more specific examples of the present disclosure will be described below. In an effort to provide a concise description of these examples, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various examples of the present disclosure, the articles “a,” “an,” “the,” and “said” are intended to mean that there are one or more of the elements. The terms “comprising,” “including,” and “having” are intended to be inclusive and mean that there may be additional elements other than the listed elements.

The present disclosure relates generally to generating personalized summary videos. More specifically, the present disclosure relates to artificial intelligence (AI) techniques employed to generate a personalized summary videos, such as a daily personalized summary videos relating to a television or streaming event (e.g., a televised or streamed multi-sport event), with respect to preferences entered by a user. It should be noted that “personalized summary video” as used herein may include a video component and an audio component, as described in greater detail below.

Certain television or streaming events, such as televised or streamed multi-sport, multi-day, multi-episode, and/or multi-season affairs or events (e.g., the Olympics, the Commonwealth games, the Pan American Games, the Asian Games, the Mediterranean Games, reality television (TV) programs, such as a reality TV season or series, music festivals, primary or general elections and corresponding coverage, seasons of sports leagues such as the National Basketball Association (NBA), the Premier League, the National Football League (NFL), Major League Baseball (MLB), a sitcom season and/or series, a movie series, etc.), have a wealth of media (e.g., digital media, including video highlights, expert commentary, etc.) available to observers of the event. This wealth of media can complicate or otherwise burden a user's ability to locate specific media relating to specific aspects of the event that are of interest to the user. As described in detail below, presently disclosed examples include various features configured to negate, reduce, or mitigate such complications or burdens, thereby improving a user experience relative to traditional configurations. While certain instances of the present disclosure refer to a multi-sport event, it should be understood that the same systems, methods, and techniques may be applicable to other relatively long (e.g., multi-day) events (e.g., live events), such as a sporting season or series having multiple games, a music festival, a primary or general election and corresponding coverage, a reality television (TV) program (e.g., a reality TV season or series), a recorded educational or professional conference, a sitcom program (e.g., a sitcom season or series), a movie series, and the like. Further, it should be understood that “event,” as used herein, may include any affair or affairs covered in media and of relative importance to a wide range of users (e.g., consumers). That is, while certain specific types of events are described above and below, it should be understood that presently disclosed examples are applicable to other types of events/affairs. In general, presently disclosed examples include features that implement AI techniques and/or integration of such AI techniques with human auditing techniques for producing (e.g., with reduced processing steps and/or editorial review relative to traditional configurations) personalized coverage in a digestible and interesting way to individual users (e.g., consumers of such coverage, users interested in the event/affair, etc.).

Continuing with the discussion above, presently disclosed examples may include an application (e.g., mobile application, computer application, etc.) configured to receive various data from various user interface devices (UIDs) corresponding to various users. The data may include, for example, personal data (e.g., names of the users) and preference data relating to, for example, the multi-sport event. The preference data may include an indication of whether a user is a casual or avid observer of the event, an indication of specific aspects of the multi-sport event that are of interest to the user (e.g., specific sports, specific athletes, specific countries, specific ceremonies, specific stages of a particular sporting event (e.g., a medal stage), specific commentators and/or voice talents, etc.), and the like. Based on the personal data and/or the preference data, a personalized summary video (e.g., on a daily basis) may be generated using various Artificial Intelligence (AI) and other techniques for playback to the user via the UID corresponding to the user. For example, a sub-set of media samples may be selected, based on the preference data corresponding to the user, from a bank of media samples stored in a database system, where the sub-set of media samples are included in the personalized summary video intended for the user. The bank of media samples may include, for example, recordings or highlights of various events in the multi-sport event, recordings of commentary or other coverage of various events in the multi-sport event, and the like.

In some examples, AI techniques are employed to select the sub-set of media samples based on the preference data corresponding to the user. Additionally or alternatively, AI techniques may be employed to generate a voiceover script based at least in part on the selected sub-set of media samples (e.g., such that the voiceover script corresponds to the media included in the sub-set of media samples). The voiceover script may be generated using the metadata from the video samples along with other sources of data (e.g., audio or closed captioning from the previous video broadcast associated with the video sample). In an aspect, the metadata may describe the type of event (e.g., Olympic, Paralympic), day of the event, stage of the event (e.g., final, semifinal), and key highlights (e.g., major athletes participating in the event). The metadata may also indicate whether a video sample is a must see clip (e.g., indexed for importance), intended audience age, intended audience demographic, a team or individual activity, and a type of activity (e.g., diving). Generative AI (GenAI) techniques may be employed to produce a voiceover from the voiceover script. In some examples, a voice employed in the GenAI techniques to produce the voiceover from the voiceover script is selected based at least in part on the preference data provided by the user via the UID. Additionally or alternatively, the personal data corresponding to the user, such as the user's name, may be employed in generating the voiceover script and subsequent voiceover. That is, the user's name and other possible personal information (e.g., personal identifying data) may be included in the voiceover.

The sub-set of media samples and the voiceover may be integrated to produce the personalized summary video corresponding to the multi-sport event (e.g., on a daily basis). In some examples, one or more auditors may employ one or more auditor devices to review the personalized summary video prior to the personalized summary video being accessible on the UID of the user. In some examples, the auditors employing the auditor devices do not review every single personalized summary video generated by the system, nor do they review every single clip (e.g., media sample, block summary, etc.) included in any given personalized summary video generated by the system, but instead a sub-set of the videos and/or clips. For example, the auditor may employ the auditing device to audit (e.g., review) one or more clips suggested via AI techniques for auditing (e.g., review). Additionally or alternatively, the auditor may employ the auditing device to audit (e.g., review) only certain types of clips, such as a block summary clip generated based at least in part on AI techniques. These and other aspects relating to the integrating of AI techniques and auditing (e.g., human auditing) will be described in greater detail with reference to the drawings.

After auditing, the personalized summary video corresponding to the user may be accessible from the UID corresponding to the user. In some examples, the personalized summary video is a continuous video having a single manifest (e.g., generated by stitching together multiple discrete segments to produce the continuous video). In other examples, the personalized summary video is displayable on the UID in the form of a playlist having multiple discrete segments (e.g., media samples, video clips, video blocks, block summaries, etc.), each discrete segment having its own manifest. The playlist may enable the user, in certain examples, to select various individual segments (or portions thereof) included in the playlist, rewind through various segments or portions of the personalized summary video, fast forward through various segments or portions of the personalized summary video, etc. Additionally or alternatively, regardless of whether the personalized summary video is a single continuous video or in the form of a playlist, the personalized summary videos for all users may include a common portion (e.g., consistent across all personalized summary videos for that day) and a personalized portion (e.g., varying based on the personal data and/or preference data described above).

Additional details regarding presently disclosed systems, methods, and techniques, such as details relating to identifying commonalities in personal data and/or preference across multiple users, also referred to as an overlap in personal data and/or preferences between multiple users, in an effort to reduce processing power and/or processing time for generating multiple personalized summary videos for the multiple users, will be provided in detail below with reference to the drawings. In general, and as previously described, presently disclosed systems, methods, and techniques negate, reduce, or mitigate, relative to traditional configurations, a burden on users attempting to acquire specific media relating to an event (e.g., multi-sport event, multi-day event, live event, etc.) having a wealth of media available to the users. That is, presently disclosed systems, methods, and techniques improve a user experience in consuming media relating to the event. These and other aspects of the present disclosure are described in detail below with reference to the drawings.

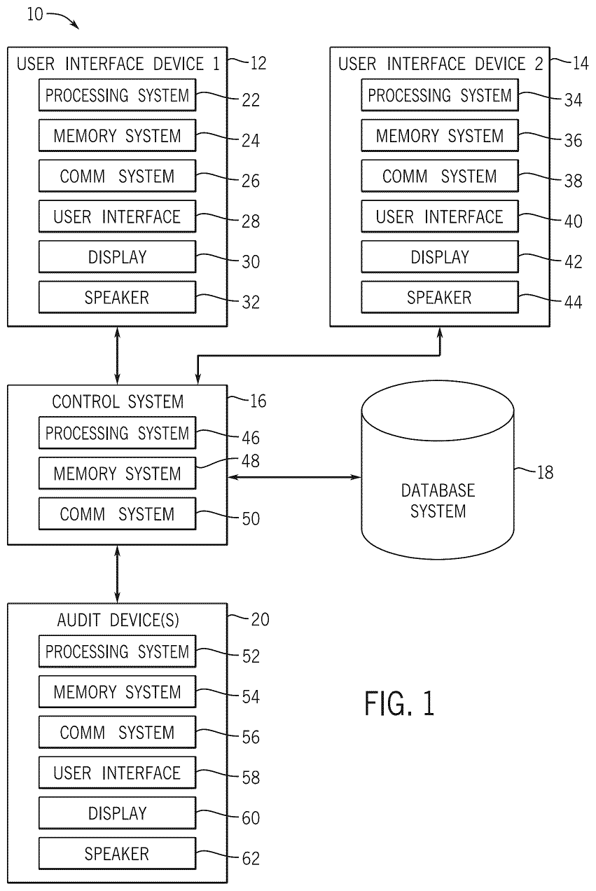

Continuing now to the drawings, FIG. 1 is a schematic illustration of an example of a system 10 configured to generate personalized summary videos of an event, such as daily personalized summary videos of a television or streaming event (e.g., a televised or streamed multi-sport event), using Artificial Intelligence (AI) techniques. In the illustrated example, the system 10 includes a first user interface device (UID) 12 corresponding to a first user, a second UID 14 corresponding to a second user, a control system 16, a database system 18, and one or more audit devices 20. In general, the first UID 12, the second UID 14, the control system 16, the database system 18, and the one or more audit devices 20 are configured to interact to generate a first personalized summary video for playback by the first UID 12 and a second personalized summary video for playback by the second UID 14, where the first personalized summary video is personalized to the first user corresponding to the first UID 12, and the second personalized summary video is personalized the second user corresponding to the second UID 14. As previously described, each personalized summary video may correspond to one day of a multi-day event, such as a multi-sport event. That is, as described in greater detail below, the system 10 may produce a plurality of first personalized summary videos over a plurality of days of the multi-day event for playback by the first UID 12, and a plurality of second personalized summary videos over the plurality of days for the multi-day event for playback by the second UID 14.

In the illustrated example, the first UID 12 includes a processing system 22 (e.g., one or more processors, referred to in certain instances of the present disclosure as processing circuitry), a memory system 24 (e.g., one or more memories, referred to in certain instances of the present disclosure as memory circuitry), a communication system 26 (e.g., one or more transceivers), a user interface 28, a display 30, and a speaker 32, among other possible componentry. In some examples, the user interface 28 and the display 30 are integrated (e.g., via a touchscreen). Likewise, the second UID 14 includes a processing system 34, a memory system 36, a communication system 38, a user interface 40, a display 42, and a speaker 44. The first UID 12 and the second UID 14 may be communicatively coupled with the control system 16 (e.g., via the Internet) such that data can be transmitted between the control system 16 and the UIDs 12, 14.

The control system 16 may correspond to one or more computers, one or more servers (e.g., webservers), one or more other computing devices, or a combination thereof. As shown, the control system 16 may include a processing system 46, a memory system 48, and a communication system 50, as shown. The first UID 12 and the second UID 14 may be configured to access an application (e.g., a computing application, a mobile application, etc.) hosted by the control system 16 (e.g., one or more webservers).

The application may include an onboarding procedure by which the user of the first UID 12 and the user of the second UID 14 provide various information, such as preferences related to the multi-sport event, personalized information (e.g., names) of the users, and the like. In this way, the first user may transmit, via the first UID 12, preference data and personal data to the control system 16. Likewise, the second user may transmit, via the second UID 14, preference data and personal data to the control system 16. In some examples, the application (e.g., hosted by the control system 16 and accessible by the first UID 12 and the second UID 14) may present various preference options selectable by the users, also referred to as user preference options. For example, the preference options may include a first option indicating a casual observer, a second option indicating an avid observer, a third option corresponding to a first sport in the multi-sport event, a fourth option corresponding to a second sport in the multi-sport event, a fifth option corresponding to a first athlete participating in a sporting event of the multi-sport event, a sixth option corresponding to a second athlete participating in the sporting event of the multi-sport event, a seventh option corresponding to a first country participating in the multi-sport event, and an eighth option corresponding to a second country participating in the multi-sport event, among other possible options (e.g., indications of a stage of competition, such as a preliminary stage, a finals stage, etc.). Additionally or alternatively, in some examples, the preference data and/or the personal data (or one or more portions thereof) may be obtained by the control system 16 from another source. As an example, the control system 16 may determine preference data and/or the personal data based on known user behavior of the users corresponding to the first UID 12 and the second UID 14.

The control system 16 may employ the preference data to select a sub-set of media samples relating from a plurality of media samples related to the multi-sport event and stored in the database system 18. The plurality of media samples may include, for example, highlights of various sports in the multi-sport event, commentary regarding the multi-sport event or individual sports therein, etc. Further, each media sample of the plurality of media samples may be tagged (or otherwise include) various metadata, such as metadata indicating an athlete at issue in the media sample, a country at issue in the media sample, a sport at issue in the media sample, a stage of competition at issue in the media sample, whether the media sample is more suitable to a casual or avid observer, whether the media sample is a highlight or commentary, etc. The control system 16 may determine the sub-set of media samples by identifying a correspondence between the preference data and the metadata associated with the sub-set of media samples. In this way, the control system 16 may select a first sub-set of media samples for the first user based on the preference data relating to the first user, and a second sub-set of media samples for the second user based on the preference data relating to the second user. As described in greater detail below, the first sub-set of media samples is selected for inclusion in a first personalized summary video for the first user, and the second sub-set of media samples is selected for inclusion in a second personalized summary video for the second user.

In some examples, the control system 16 may identify a correspondence between (e.g., a match or similarity between, an overlap between, a commonality between) the preference data relating to the first user and the preference data relating to the second user and, then, may select a common sub-set of media samples for the first user and the second user, or may use (e.g., borrow, re-use) the first sub-set of media samples previously selected for the first user as the second sub-set of media samples for the second user. In some examples, template media-sample sets may be generated and then selected for various users based on the control system 16 identifying correspondences between the preference data associated with such users and the template media sample sub-set(s). In this way, in certain examples, the control system 16 need not perform the media sample sub-set selection step (or at least an entirety thereof) with respect to all users of the service.

In some examples, the control system 16 may employ Artificial Intelligence (AI) techniques for selecting the various sub-sets of media samples from the plurality of media samples stored in the database system 18. Additionally or alternatively, the control system 16 may employ AI techniques for generating voiceover scripts. For example, the control system 16 may generate a first voiceover script for the first personalized summary video corresponding to the first user (e.g., based on the preference data corresponding to the first user, the personal data corresponding to the first user including a name of the second user, the first sub-set of media samples, or any combination thereof) and a second voiceover script for the second personalized summary video corresponding to the second user (e.g., based on the preference data corresponding to the second user, the personal data corresponding to the second user including the name of the second user, the second sub-set of media samples, or any combination thereof). Additionally or alternatively, the control system 16 may employ generative Artificial Intelligence (GenAI) techniques to generate a first voiceover from the first voiceover script and a second voiceover from the second voiceover script. In some examples, the control system 16 may employ the preference data corresponding to the first user and the second user, such as an indication of preferred commentators and/or voice talents, to generate the first voiceover from the first voiceover script and the second voiceover from the second voiceover script. In general, each voiceover script and corresponding voiceover of a personalized summary video are generated to spatially align with the sub-set of media samples corresponding to the personalized summary video. In this way, the control system 16 generates the personalized summary video from the sub-set of media samples and the voiceover such that descriptive comments/commentary in the voiceover align with the sub-set of media samples when the personalized summary video is played back, for example, on the first UID 12 or the second UID 14.

As previously described, the event, such as the multi-sport event, may take place over the course of multiple days. Accordingly, the control system 16 may be configured to generate daily personalized summary videos for the first user of the first UID 12 and the second user of the second UID 14 via the above-described techniques. That is, the control system 16 may generate a first personalized summary video for the first user on a first day of the multi-sport event and an additional first personalized summary video for the first user on a second day of the multi-sport event. Likewise, the control system 16 may generate a second personalized summary video for the second user on a second day of the multi-sport event and an additional second personalized summary video for the first user on a second day of the multi-sport event. In this way, the first user and the second user can follow the multi-sport event from its beginning to its end, receiving content personalized to the first user and the second user and provided on a daily basis (e.g., recapping the current or prior day's event or events with each summary video). In some examples, the onboarding procedure by which users provide preference data and personal data is only performed once with respect to each user (e.g., at a start of the multi-sport event or when the user registers for the service). Additionally or alternatively, the onboarding procedure (or a portion thereof) may be available for updating throughout the multi-sport event (e.g., such that users can change the preference data, the personal data, or both).

In some examples, some or all of the personalized summary videos (e.g., daily personalized summary videos) are audited prior to the control system 16 making them available to the users and corresponding user interface devices (e.g., first UID 12 and/or second UID 14). For example, the audit device(s) 20 may be employed by auditors (e.g., humans) to review some or all of the personalized summary videos. As shown, the audit device(s) 20 may include a processing system 52, a memory system 54, a communication system 56, a user interface 58, a display 60, and a speaker 62. In this way, the audit device(s) 20 may be capable of outputting the personalized summary videos to the auditor in the same or similar way they would be output to the first UID 12 and/or the second UID 14. The auditor(s) corresponding to the audit device(s) 20 may approve the personalized summary videos, revise the personalized summary videos, and/or suggest revisions to the personalized summary videos. It should be noted that automated auditing techniques (e.g., via automated AI auditing techniques) may also be employed.

After the personalized summary videos are generated and/or approved, the control system 16 may make them available to the first UID 12 (e.g., the first personalized summary video) and/or the second UID 14 (e.g., the second personalized summary video) for consumption. That is, the first personalized summary video may be played by the first UID 12 such that the video component is presented on the display 30 thereof and the audio component is output by the speaker 32 thereof. Likewise, the second personalized summary video may be played by the second UID 14 such that the video component is presented on the display 42 thereof and the audio component is output by the speaker 44 thereof. In some examples, a first playlist corresponding to the first personalized summary video is available to the first UID 12 enabling rewinding, fast forwarding, media sample selection, etc. Likewise, a second playlist corresponding to the second personalized summary video is available to the second UID 14 enabling rewinding, fast forwarding, media sample selection, etc.

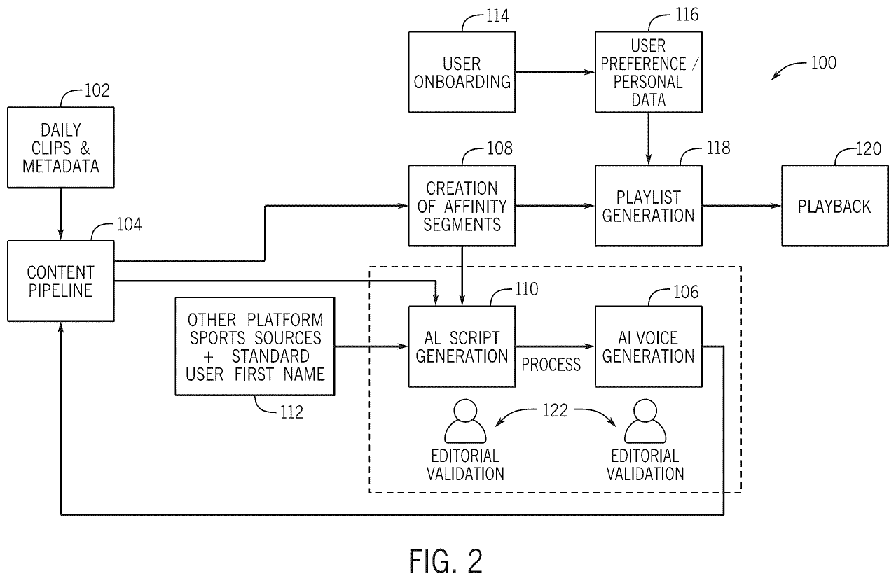

FIG. 2 is a process flow diagram illustrating an example of a workflow 100 implemented by the system 10 of FIG. 1 to generate personalized summary videos of an event, such as daily personalized summary videos of a television or streaming event (e.g., a multi-sport event), using Artificial Intelligence (AI) techniques. The illustrated workflow 100 may be implemented on a daily basis over the course of the multi-sport event, as previously described. In the illustrated example, the workflow 100 includes daily media samples 102 (or “clips”) input to a content pipeline 104. The content pipeline 104 may also receive voiceovers 106 generated via GenAI techniques, as shown, in certain examples. Indeed, in some examples, previously generated voiceovers 106 may be employed in subsequent personalized summary videos (e.g., based on identified correspondences or commonalities with the preference and/or personal data of other users).

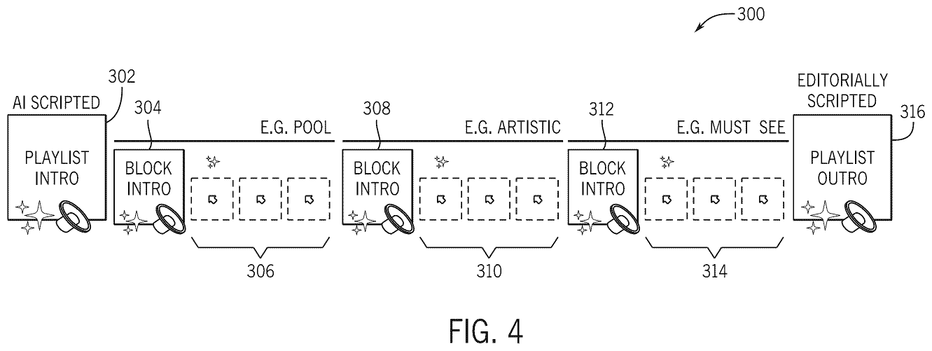

The content pipeline 104 is employed for creation of affinity segments 108, as shown, which are employed for voiceover script generation 110 (e.g., via AI techniques). For example, the affinity segments 108 may correspond to clip or sample blocks (e.g., where each clip or sample block corresponds to a particular theme, such as pool events), described in greater detail with reference to FIG. 4. After creation of the affinity segments 108 (e.g., clip or sample blocks), the AI script generation 110 may include generating a script for each clip or sample block, such as a script for a summary video pertaining to the clip or sample block. As an example, a first clip or sample block (i.e., a first affinity segment 108) may include three clips corresponding to pool events, and a first script summarizing the three clips may be generated at block 110 for inclusion as an intro to the three clips included in the first clip or summary block (i.e., the first affinity segment 108). That is, the script may be based on the three clips included in the first clip or sample block (i.e., the first affinity segment 108). Additionally, a second clip or sample block (i.e., a second affinity segment 108) may include three clips corresponding to artistic events, and a second script summarizing the three clips may be generated at block 110 for inclusion as an intro to the three clips included in the second clip or summary block (i.e., the second affinity segment 108). That is, the script may be based on the three clips included in the second clip or sample block (i.e., the second affinity segment 108). By breaking the content from the content pipeline 104 into these sample or clip blocks (i.e., affinity segments 108) and generating scripts and subsequent voiceovers from these sample or clip blocks (i.e., affinity segments 108), processing steps and editorial review are reduced over traditional configurations.

A bank 112 of other platform sports sources and standard user names may also be employed for the voiceover script generation 110, as shown. The voiceover script generation 110 is employed for generating the voiceovers 106 described above, which may include a playlist intro, clip or sample blocks (i.e. affinity segments 108) intros, and a playlist outro in certain examples. A user onboarding 114 process is employed in the workflow 100 to identify user preferences and personal data 116, as previously described, which are employed to generate a playlist 118 (e.g., corresponding to or associated with a personalized summary video). The affinity segments 108 are also employed to generate the playlist 118. Indeed, the affinity segments 108 may include a database system with a plurality of media samples stored thereon, various AI generated voiceovers stored thereon, etc., which may be selected from at generation of the playlist 118 and based on the user preferences and personal data 116 (e.g., in accordance with the description above corresponding to FIG. 1). The playlist 118 (e.g., personalized summary video) is output or otherwise made available to a UID for playback 120. In some examples, editorial validation 122 (e.g., auditing) may be employed in the workflow 100 at the voiceover script generation 110 and/or the voiceover generation 106 steps.

By employing the above-described workflow 100 in the context of the system 10 of FIG. 1, processing steps are reduced relative to configurations in which all processing steps are performed for each user of the service. As an example, instead of generating a new voiceover for each user having the name “Mike,” a common voiceover (or portion thereof) for each user having the name “Mike” may be used via the workflow 100 in FIG. 2. As another example, instead of newly selecting the same sub-set of media samples (or portion thereof) for each user having the same or similar preference data, a common sub-set of media samples (or portion thereof) may be used via the workflow 100 in FIG. 2. Other examples are also possible in accordance with the present disclosure.

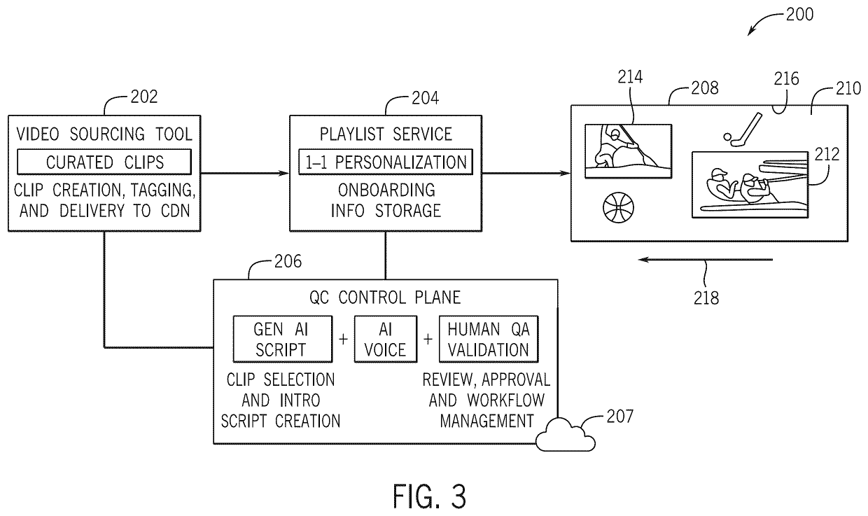

FIG. 3 is a process flow diagram illustrating an example of various logic 200 (e.g., hardware and/or software) employed in certain steps of the workflow 100 of FIG. 2 for generating personalized summary videos of an event, such as daily personalized summary videos of a television or streaming event (e.g., a multi-sport event), using Artificial Intelligence (AI) techniques. As shown, the logic 200 includes a video sourcing tool 202 (e.g., an indexed database or other system having curated clips with clip creation, tagging for metadata purposes, and delivery to content delivery network [CDN]) communicating with a playlist service 204 and a quality control (QC) control panel 206. The QC control panel 206 is employed for generating AI voiceover scripts (e.g., clip selection and intro script creation), generating AI voiceovers from the AI voiceover scripts, and/or human validation, as shown. In some examples, the human validation is only employed with respect to certain summary videos (e.g., in continuous or playlist form), certain segments of certain summary videos (e.g., in continuous or playlist form), etc., as described in greater detail with reference to FIG. 4. The playlist service 204 is employed for generating personalized summary videos (e.g., on a daily basis) based at least in part on inputs from the video sourcing tool 202 and the QC control panel 206, as shown. In some examples, various cloud computing 207 techniques may be employed at the QC control panel 206.

Further, a UID 208 (e.g., a smartphone, a computer, etc.) is employed for playback of the personalized summary video(s) generated by the playlist service 204. As shown at the UID 208 in FIG. 3, in some examples, the personalized summary video may include a background graphic 210 with windows 212, 214 overlaid therein, and the media samples or portions thereof (e.g., highlight videos) may appear in the windows 212, 214 as the personalized summary video is played back by the UID 208. Further, in some examples, the personalized summary video (including the background graphic 210 and the windows 212, 214 with the media samples or portions thereof therein) may appear to move across a display 216 of the UID 208 (e.g., in a direction 218) as the personalized summary video is played. In this way, additional windows with additional media samples may appear over a duration of the personalized summary video.

FIG. 4 is a schematic illustration of an example of a playlist structure 300 corresponding to a daily personalized playlist including personalized summary video clips and deliverable to an end user. In the illustrated example, the playlist structure 300 includes a playlist intro 302 generated, for example, via AI techniques previously described above. In some examples, the playlist intro 302 includes personalized audio, such as the user's name. The playlist structure 300 also includes a first block intro 304 corresponding to a first block having first media samples 306 related to the first block. As an example, the first block may correspond to pool events of a first day in the multi-sport event, where pool events were selected based on the preference data of the user. The playlist structure 300 also includes a second block intro 308 corresponding to a second block having second media samples 310 related to the second block. As an example, the second block may correspond to artistic events of the first day in the multi-sport event, where artistic events were selected based on the preference data of the user. The playlist structure 300 also includes a third block intro 312 corresponding to a third block having third media samples 314 related to the third block. As an example, the third block may correspond to “must see” events of the first day in the multi-sport event. In some examples, the “must see” events (or corresponding block) are selected based on the user preferences of the user, while in other examples, the “must see” events (or corresponding block) are provided to all users of the service.

In an aspect, the block intros (e.g., the first block intro 304, the second block intro 308, and/or the third block intro 312) may include an AI-generated script providing an overview or summary of the AI-selected clips related to the respective block intro. For example, the first block intro 308 for pool events may include an AI-generated overview or summary of the pool event clips to follow, including an AI-generated voiceover. With reference to FIG. 3, the QC control panel 206 (which may include any or all of the auditing device(s) described with respect to FIGS. 1 and 2) may be employed to audit, review, and/or validate the block intros 304, 308, 312, the playlist intro 302 and the playlist outro 316, or a combination thereof or portions thereof (e.g., segments of the playlist structure 300 generated via AI techniques). It should be understood that the QC control panel 206 of FIG. 3 may be employed for auditing, reviewing, and/or validating any aspect of the playlist structure 300 and corresponding playlist segments, but that in some examples, specific segments of the playlist structure 300 (e.g., segments identified via AI techniques as potentially benefiting from QC) may be audited, reviewed, and/or validated. Further, in some examples, not all personalized summary videos (e.g., in continuous or playlist form) for all users are audited, reviewed, and/or validated. For example, certain personalized summary videos (e.g., in continuous or playlist form) or groups of such personalized summary videos may be identified via AI techniques for QC. Criteria that may be considered for identifying personalized summary videos (or portions or segments thereof) or groups thereof for QC/QA/review/auditing/validation may include a uniqueness of the AI content relative to other (e.g., past) AI content generated by the system, a correspondence between the AI content in the personalized summary video (or portions or segments thereof) and sensitive/flagged/flaggable content, etc.

Integration of AI and QC/validation techniques described above leverage the expansive personalization options available via AI while employing enough controls to ensure that appropriate and engaging content is delivered to end users. Further, employing the block strategy as outlined above may, in some examples, reduce processing steps for generating the personalized summary videos, save significant editorial review and auditing, and/or impart other technical benefits over traditional configurations. For example, any user that selects “pool events” in their preference options may receive the first block intro 304 and the first media samples 306 corresponding thereto. However, it should be understood that further personalization and/or customization is also possible, such as generating a first version of the first media samples 306 that emphasizes a particular first athlete in the pool events based on a first user's preference for the particular first athlete, and generating as second version of the first media samples 306 that emphasizes a particular second athlete in the pool events based on a second user's preference for the particular second athlete. The playlist may include a playlist outro 316, as shown, which may be AI scripted or editorially scripted.

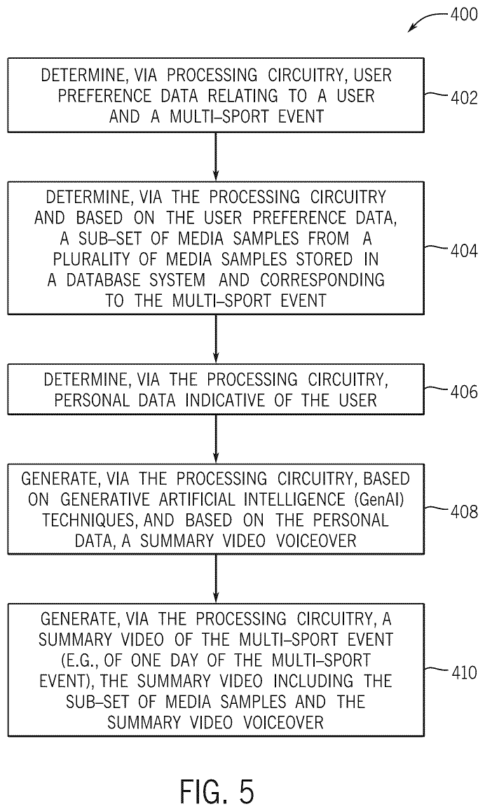

FIG. 5 is a process flow diagram illustrating an example of a method 400 (e.g., computer-implemented method) of generating personalized summary videos of an event, such as daily personalized summary videos of a television or streaming event (e.g., a multi-sport event), using Artificial Intelligence (AI) techniques. An order of the steps of the method 400 illustrated in FIG. 5 and described below should not be taken as necessarily implying a chronology of all examples of the method 400. Indeed, while the steps of the method 400 may be performed in a chronology corresponding to the order illustrated in FIG. 5 and described below, other chronologies are also possible in accordance with presently disclosed examples. Further, certain steps illustrated in FIG. 5 and described below may be excluded in certain examples of the method 400, and certain steps not illustrated in FIG. 5 and not described below may be included in certain examples of the method 400.

In the illustrated example, the method 400 includes determining (block 402), via processing circuitry, user preference data relating to a multi-sport event (or other event over the course of multiple days). For example, the user preference data may indicate sports, countries, athletes, and/or events (e.g., ceremonies, stages of competition, etc.) of interest to a user. Additionally or alternatively, the user preference data may indicate a commentator or voice talent of interest to the user. Additionally or alternatively, the user preference data may indicate whether the user is an avid or casual observer of the event (e.g., multi-sport event). The preference data may be provided by a user interface device corresponding to the user, derived from known user behavior of the user, or both.

The method 400 also includes determining (block 404), via the processing circuitry and based on the user preference data, a sub-set of media samples from a plurality of media samples stored in a database system and corresponding to the multi-sport event. For example, the plurality of media samples may include metadata (e.g., tags) indicating various information regarding the plurality of media samples, such as whether each media sample is a highlight or commentary, a sport associated with each media sample, a country and/or athlete associated with each media sample, a competition stage associated with each media sample, or other identifying information. The sub-set of media samples may be selected based at least in part on a correspondence between the user preference data and the metadata associated with the sub-set of media samples (and/or each media sample within the sub-set).

The method 400 also includes determining (block 406), via the processing circuitry, personal data indicative of the user. The personal data may include a name of the user, an age of the user, a socioeconomic or other class of the user, an occupation of the user, etc. The personal data may be provided by the user interface device of the user, derived from known user behavior of the user, or both. The method 400 also includes generating (block 408), via the processing circuitry, based on generative Artificial Intelligence (GenAI) techniques, and based on the personal data, a summary video voiceover. In an aspect, the summary video voiceover may be assigned the same identifier as the summary video to which the voiceover is associated. For example, the summary video voiceover may include audio portions reflecting some or all of the personal data (e.g., the user's name) referenced with respect to block 406 above. In an aspect, if the summary video voiceover includes the user's name, the processing circuitry may first determine whether the user's name is contained within a whitelist of names. If so, the user's name may be utilized in the voiceover, and if not, then the user's name may be excluded from the voiceover. In some examples, the summary video voiceover is generated based at least in part on the preference data and/or the sub-set of media samples selected at block 404. For example, the summary video voiceover may include descriptive commentary aligned with the sub-set of media samples. Additionally or alternatively, the summary video voiceover may include a voice talent or commentator selected in view of the user preferences. As an example, the summary video voiceover, including descriptive commentary, the personal data, etc., may be uttered by an AI version of the voice talent or commentator.

The method 400 also includes generating (block 410), via the processing circuitry, a summary video of the multi-sport event (e.g., of one day of the multi-sport event), where the summary video includes the sub-set of media samples and the summary video voiceover. That is, the sub-set of media samples and the summary video voiceover may be integrated to form the summary video (e.g., personalized daily summary video) subsequently made accessible for playback on the user device of the user.

In an aspect, while the summary video is being played back or after watching the summary video, the user may be given an option to update preferences to modify future summary videos. For example, the user may be allowed to add/remove sports of interest, add/remove specific athletes from a sport (and when removing an athlete, still have summary clips from that sport generated but with one or more athletes removed), or add/remove important events such as final events and medal ceremonies.

In another aspect, the user may opt in or opt out of the summary video service. If the user opts in to the summary video service, the user may be given an option of whether to watch a customized summary video service as described, or the user may be given an option to watch a default summary video where the videos are selected without taking into account the user's preferences.

In another aspect, the summary videos may be ad-free regardless of the subscription level of the user. Any features discussed with respect to FIGS. 1-4 may also be included in the method 400 of FIG. 5.

While only certain features of the present disclosure have been illustrated and described herein, many modifications and changes will occur to those skilled in the art. It is, therefore, to be understood that the appended claims are intended to cover all such modifications and changes as fall within the true spirit of the present disclosure.

1. A computer-implemented method, comprising:
determining, via processing circuitry, user preference data relating to a user and a television or streaming event;
determining, via the processing circuitry and based on the user preference data, a sub-set of media samples from a plurality of media samples stored in a database system and corresponding to the television or streaming event;
determining, via the processing circuitry, personal data indicative of the user;
generating, via the processing circuitry, based on generative Artificial Intelligence (GenAI) techniques, and based on the personal data, a summary video voiceover; and
generating, via the processing circuitry, a summary video of the television or streaming event, the summary video comprising the sub-set of media samples and the summary video voiceover.

2. The computer-implemented method of claim 1, comprising generating, via the processing circuitry, the summary video voiceover based on the GenAI techniques, the personal data, and the user preference data.

3. The computer-implemented method of claim 1, comprising generating, via the processing circuitry, a script corresponding to the summary video voiceover based on:
the personal data, the user preference data, the sub-set of media samples, or a combination thereof; and
the GenAI techniques or additional Artificial Intelligence (AI) techniques.

4. The computer-implemented method of claim 1, comprising presenting, via the processing circuitry and to a user interface device corresponding to the user, a plurality of user preference options from which user preferences corresponding to the user preference data are selectable by the user.

5. The computer-implemented method of claim 4, wherein the plurality of user preference options comprises two or more of:
a first option indicating a casual observer;
a second option indicating an avid observer;
a third option corresponding to a first sport in the television or streaming event;
a fourth option corresponding to a second sport in the television or streaming event;
a fifth option corresponding to a first athlete participating in a sporting event of the television or streaming event;
a sixth option corresponding to a second athlete participating in the sporting event of the television or streaming event;
a seventh option corresponding to a first country participating in the television or streaming event; or
an eighth option corresponding to a second country participating in the television or streaming event.

6. The computer-implemented method of claim 1, comprising:
determining, via processing circuitry, additional user preference data relating to an additional user and the television or streaming event;
determining, via the processing circuitry and based on the additional user preference data, an additional sub-set of media samples from the plurality of media samples stored in the database system and corresponding to the television or streaming event;
determining, via the processing circuitry, additional personal data indicative of the additional user;
generating, via the processing circuitry, based on the GenAI techniques, and based on the additional personal data, an additional summary video voiceover; and
generating, via the processing circuitry, an additional summary video of the television or streaming event, the additional summary video comprising the additional sub-set of media samples and the additional summary video voiceover.

7. The computer-implemented method of claim 6, comprising:
determining, via the processing circuitry, an overlap between the personal data and the additional personal data; and
generating, via the processing circuitry and in response to the overlap, the additional summary video voiceover based at least in part on a portion of the summary video voiceover.

8. One or more tangible, non-transitory, computer-readable media storing instructions thereon that, when executed by processing circuitry, are configured to cause the processing circuitry to:
determine user preference data relating to a user and a television or streaming event;
determine, based on the user preference data, a sub-set of media samples from a plurality of media samples stored in a database system and corresponding to the television or streaming event;
determine personal data indicative of the user;
generate, based on generative Artificial Intelligence (GenAI) techniques and based on the personal data, a summary video voiceover; and
generate a summary video of the television or streaming event, the summary video comprising the sub-set of media samples and the summary video voiceover.

9. The one or more tangible, non-transitory, computer-readable media of claim 8, wherein the instructions, when executed by the processing circuitry, are configured to cause the processing circuitry to generate the summary video voiceover based on the GenAI techniques, the personal data, and the user preference data.

10. The one or more tangible, non-transitory, computer-readable media of claim 9, wherein the instructions, when executed by the processing circuitry, are configured to cause the processing circuitry to generate the summary video voiceover by:
selecting, based on the user preference data, a voice talent or commentator from a plurality of available voice talents or commentators; and
generating, via the GenAI techniques and based on the personal data, a portion of the summary video voiceover in which a name of the user is uttered via a generative AI version of the voice talent or commentator.

11. The one or more tangible, non-transitory, computer-readable media of claim 8, wherein the instructions, when executed by the processing circuitry, are configured to cause the processing circuitry to generate a portion of the summary video voiceover in which descriptive commentary is related to the sub-set of media samples.

12. The one or more tangible, non-transitory, computer-readable media of claim 8, wherein the instructions, when executed by the processing circuitry, are configured to cause the processing circuitry to present, to a user interface device corresponding to the user, a plurality of user preference options from which user preferences corresponding to the user preference data are selectable by the user.

13. The one or more tangible, non-transitory, computer-readable media of claim 8, wherein the instructions, when executed by the processing circuitry, are configured to cause the processing circuitry to determine the user preference data based on stored user behavior data corresponding to the user.

14. The one or more tangible, non-transitory, computer-readable media of claim 8, wherein the plurality of media samples, including the sub-set of media samples, comprises video highlights of the television or streaming event.

15. A system, comprising:
a database system storing a plurality of media samples relating to a television or streaming event; and
processing circuitry configured to:
determine user preference data relating to a user and the television or streaming event;
determine, based on the user preference data, a sub-set of media samples from the plurality of media samples stored;
determine personal data indicative of the user;
generate, based on generative Artificial Intelligence (GenAI) techniques and based on the personal data, a summary video voiceover; and
generate a summary video of the television or streaming event, the summary video comprising the sub-set of media samples and the summary video voiceover.

16. The system of claim 15, wherein the summary video corresponds to a first day of a plurality of days of the television or streaming event, and wherein the processing circuitry is configured to:
determine, based on the user preference data, an additional sub-set of media samples from an additional plurality of media samples stored in the database system and corresponding to the television or streaming event;
generate, based on the GenAI techniques and based on the personal data, an additional summary video voiceover; and
generate an additional summary video of the television or streaming event, the additional summary video comprising the additional sub-set of media samples and the additional summary video voiceover, wherein the additional summary video corresponds to a second day of the plurality of days of the television or streaming event.

17. The system of claim 15, wherein the processing circuitry is configured to present, to a user interface device corresponding to the user, a plurality of user preference options from which user preferences corresponding to the user preference data are selectable by the user.

18. The system of claim 17, wherein the plurality of user preference options comprises two or more of:
a first option indicating a casual observer;
a second option indicating an avid observer;
a third option corresponding to a first sport in the television or streaming event;
a fourth option corresponding to a second sport in the television or streaming event;
a fifth option corresponding to a first athlete participating in a sporting event of the television or streaming event;
a sixth option corresponding to a second athlete participating in the sporting event of the television or streaming event;
a seventh option corresponding to a first country participating in the television or streaming event; or
an eighth option corresponding to a second country participating in television or streaming event.

19. The system of claim 15, wherein the processing circuitry is configured to:
determine additional user preference data relating to an additional user and the television or streaming event;
determine an additional sub-set of media samples from the plurality of media samples stored in the database;
determine additional personal data indicative of the additional user;
generate, based on the GenAI techniques and based on the additional personal data, an additional summary video voiceover; and
generate an additional summary video of the television or streaming event, the additional summary video comprising the additional sub-set of media samples and the additional summary video voiceover.

20. The system of claim 19, wherein the processing circuitry is configured to:
determine an overlap between the user preference data and the additional user preference data indicating a match between the sub-set of media samples and the additional sub-set of media samples;
select a media sample template from a plurality of media sample templates based on the overlap indicating the match; and
generate the summary video of the television or streaming event and the additional summary video of the television or streaming event based at least in part on the media sample template.
